(19) United States
(12) Patent Application Publication
(10) Pub. No.: US 2023/0208105 A1
(43) Pub. Date: Jun. 29, 2023

(54) MINIATURE SINGLE-LONGITUDINAL-MODE DIODE-PUMPED SOLID-STATE LASERS

(71) Applicants: David C. Brown, Friendsville, PA (US); Christopher L. Hancock, Chenango Forks, NY (US); Nicholas S. Tomasello, Binghmton, NY (US); James P. Cioffi, Bayside, NY (US); Sten O. Tornegård, Yardley, NY (US)

(72) Inventors: David C. Brown, Friendsville, PA (US); Christopher L. Hancock, Chenango Forks, NY (US); Nicholas S. Tomasello, Binghmton, NY (US); James P. Cioffi, Bayside, NY (US); Sten O. Tornegård, Yardley, NY (US)

(21) Appl. No.: 18/146,376

(22) Filed: Dec. 24, 2022

Related U.S. Application Data
(60) Provisional application No. 63/266,104, filed on Dec. 28, 2021.

(51) Int. Cl. H01S 5/14; H01S 5/024; H01S 5/00

(52) U.S. Cl. CPC H01S 5/141; H01S 5/02438; H01S 5/0064

(57) ABSTRACT

Systems, methods, and other embodiments for a new compact narrowband diode-pumped solid-state laser device enabled by Volume Bragg Grating (VBG) technology and capable of operating at the watt or higher output power level. This laser is stable, operates in a transverse electromagnetic (TEM) output mode, and with a single-narrowband (<1 kHz FWHM) longitudinal mode with acceptable relative intensity noise (RIN) performance from 1-100 GHz. In a preferred embodiment of the present invention, the TEM output mode is a TEM₀₀ Gaussian output mode.

### CROSS-REFERENCE TO RELATED APPLICATION

This application is a continuation-in-part of, and claims priority to U.S. Patent Application 63/266,104, filed on Dec. 28, 2021, the disclosure of which is hereby incorporated by reference in its entirety to provide continuity of disclosure to the extent such disclosure is not inconsistent with the disclosure herein.

### FIELD OF THE INVENTION

The present invention relates to solid-state lasers. In particular, the present invention relates to narrowband, single-longitudinal-mode (SLM) solid-state lasers.

### BACKGROUND

Narrowband Single-Longitudinal-Mode (SLM) lasers are important in a number of applications, including frequency metrology, light detection and ranging (LIDAR), nonlinear optics, holography, and in optical fiber communications. In recent years, the need for such devices has been embraced by the military, which desires low amplitude and phase-noise devices to enhance low noise-figure radio frequency (RF) photonic capabilities for avionic and electronic warfare (EW) applications.

In one military application, the following specifications related to low amplitude and phase-noise devices such as narrowband, single-longitudinal-mode (SLM) solid-state lasers are required:
1. Minimum of 25-50 mW Solid-State Laser Output Power After Propagation Through Single Mode, Polarization Maintaining (SM PM) Fiber.
2. Shot-Noise-Limited Behavior From 1-100 GHz.
3. Narrowband Output <1 kHz Lorentzian Full Width Half Maximum (FWHM).
4. Output Wavelengths in the 0.5 to 1.5 μm range.
5. Miniature Rugged Laser Package.

Therefore, a need exists in both field and research applications for a novel narrowband, single-longitudinal-mode (SLM) solid-state laser that is capable of providing a minimum of 25-50 mW solid-state laser output power after propagation through a single mode, polarization maintaining (SM PM) fiber, exhibits shot-noise-limited behavior from 1-100 GHz, provides a narrowband output of <1 kHz FWHM, provides output wavelengths in the range of 0.5-1.5 μm and is constructed as a miniature rugged laser package.

### BRIEF SUMMARY OF THE INVENTION

This invention is a new and novel compact narrowband diode-pumped solid-state laser device that is enabled by Volume Bragg Grating (VBG) technology and is capable of operating at the watt output power level and above. This laser is stable, operates in a transverse electromagnetic (TEM) output mode, and with a single-narrowband (<1 kHz) longitudinal mode with acceptable relative intensity noise (RIN) performance from 1-100 GHz. In a preferred embodiment of the present invention, the output beam is a TEM₀₀ Gaussian output mode.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a schematic illustration of a compact narrowband diode-pumped solid-state laser, according to various embodiments of the present invention.

FIG. 2 is a graphical illustration of temperature distribution of the compact narrowband diode-pumped solid-state laser showing a minimization of the temperature at the interface between the high k and low materials, according to various embodiments of the present invention.

FIG. 3 is a graphical illustration of the RIN spectrum of the present invention in relation to a known Nd:YAG, non-planar ring oscillator (NPRO), according to various embodiments of the present invention.

FIG. 4 is a graphical illustration of the linewidth (Lorentzian) of the present invention as compared to two commercial distributed feedback (DFB) diode lasers, according to various embodiments of the present invention.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, singular forms “a,” “an,” and “the” are intended to include the plural forms as well as the singular forms unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefits, and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A new and novel compact narrowband diode-pumped solid-state laser device that is enabled by Volume Bragg grating (VBG) technology that is capable of operating at the watt output power level and beyond is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered an exemplification of the invention and is not intended to limit the invention to the specific embodiments illustrated by the figures or description below.

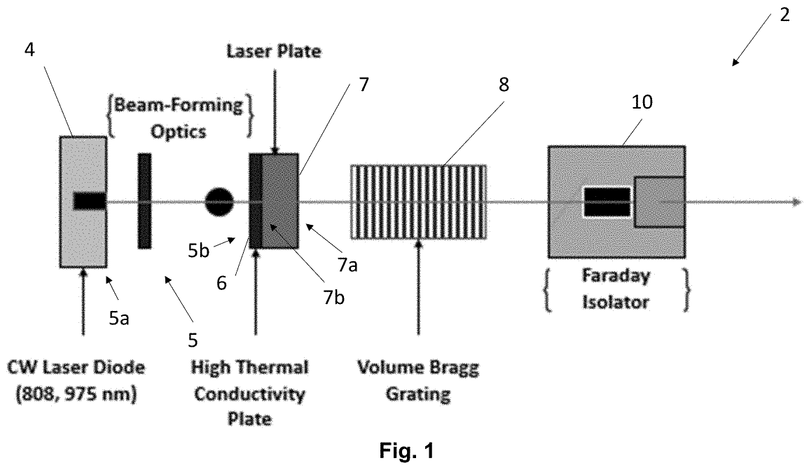

With respect to FIG. 1, there is illustrated one embodiment of application for a compact narrowband diode-pumped solid-state laser system 2, according to various embodiments of the present invention. As shown in FIG. 1, system 2 includes, in part, laser diode assembly 4, beam-forming optics assembly 5 consisting of a fast-axis collimating lens (FAC) lens 5a, and a slow-axis collimating (SAC) lens 5b, dielectric plate 6, laser plate 7, high-reflection (HR) coating 7a, Volume Bragg Grating 8, and Faraday Isolator 10.

Regarding laser diode assembly 4, in one embodiment, laser diode assembly 4 includes a watt level 975 or 808 nm continuous wave (CW) laser diode, which can be used to end-pump an active-mirror amplifier. 975 nm diodes are used to pump Yb-based lasers such as Yb,Er:Glass, and Yb:YAG, both having strong absorption bands at 975 nm, and 808 nm diodes are used to pump Nd:YVO4 or Nd:YAG, for example, with strong absorption bands near 808 nm. On occasion, shorter wavelength diodes with output near 940 nm may be used to pump the 940 nm bands of Yb-based lasers.

Regarding beam-forming optics assembly 5, in one embodiment, beam-forming optics assembly 5 can be used to produce a square excitation region in the laser plate 7. One embodiment utilizes both a fast-axis collimating (FAC) lens 5a to collimate the fast-axis of the diode, while a slow-axis collimating (SAC) lens 5b may also be used in combination with the FAC lens 5a to collimate the diode slow-axis and produce a square excitation region in the laser plate, as will be discussed in greater detail later.

Regarding dielectric plate 6, in one embodiment, dielectric plate 6 includes a high thermal conductivity (high k) (heatsink), electrically insulating dielectric plate. The high thermal conductivity dielectric laser plate 6 should also be optically clear at a pump wavelength passing through in order to efficiently optically pump the lasing ions in the low thermal conductivity laser plate 7 and be optically clear at a lasing wavelength to produce an efficient laser. Without the high k dielectric plate 6, the surface of low thermal conductivity laser plate 7 adjacent to the high k crystal will have an unacceptably high temperature, the surface of laser plate 7 will bulge and become convex (strain distortion), and the laser plate 7 will then have unacceptable thermal distortion. Thermal fracture is also a real possibility. Placing the high k plate 6 in intimate contact with the low k plate 7 significantly reduces the plate average temperature, and results in the peak temperature moving from the surface to a location inside the low k crystal about ⅓ of the crystal thickness from the low k−high k interface. This arrangement also reduces the amount of thermal focusing experienced by the laser beam, resulting in a more stable laser. A lower average temperature also results in a higher laser gain and efficiency, due to a decrease in the laser beam ground-state absorption.

The low k laser plate 7 and the high k plate 6 are bonded to each other using any number of methods, including glue, and any one of a number of types of diffusion-bonding techniques, including Van der Walls bonding or chemical diffusion-bonding.

Regarding Volume Bragg Grating (VBG) 8, in one embodiment, Volume Bragg Grating 8 includes a narrowband reflective Volume Bragg Grating with a specified diffraction-efficiency and bandwidth. The diffraction-efficiency (DE) can also be thought of as a reflectivity, and operationally the VBG can be thought of as an equivalent outcoupler. Depending on the laser and the operating wavelength, grating diffraction efficiencies vary typically from 99% to 90%, grating thicknesses vary from about 5 to over 20 mm, and FWHM spectral bandwidth from 0.1 to 0.5 nm.

It is to be understood that a semi-transparent dielectric mirror such as an outcoupler (not shown) may be used instead of the Volume Bragg Grating in cases where SLM performance is imposed using another technique (such as a very short resonator) and in cases where MLM performance is acceptable. In this instance, the outcoupler could be dielectrically coated on an exit surface of laser plate 7. In another embodiment, the outcoupler may be constructed as a conventional external curved outcoupler.

Regarding Faraday Isolator 10, in one embodiment, Faraday Isolator 10 includes a compact Faraday Isolator, which is constructed to prevent backward-traveling light from destabilizing the laser resonator formed by the high-reflection surface 7b of the laser plate 7 facing the high k plate and the diffractive efficiency (effective reflectivity) of the VBG, or traveling backward through the SAC and FAC lenses 5a and 5b, respectively, and ultimately into the laser diode which becomes unstable. A typical Faraday isolator 10 offers a transmission of 88-90% and isolation of 35-40 dB.

All the parts were chosen or designed so that the resulting laser would fit in a very compact package measuring <22 cubic centimeters.

### Operation of the Laser System

Referring to FIG. 1, operation of the system 2 begins with the delivery of a specified current and voltage to the laser diode 4, which delivers through one end (facing the beam-forming optics 5) an output pump beam for activating the laser. After leaving the output facet of the laser diode 4, the beam diverges rapidly in the “fast” axis, in this case, the vertical direction, and more slowly in the “slow” axis, here the horizontal direction. To convert the diode output beam into a square pump beam that remains collimated as it passes through the laser plate 7, we use a fast-axis collimating lens (FAC) lens 5a to collimate the vertical direction, and a slow-axis collimating (SAC) lens 5b to collimate the diode horizontal axis. The FAC lens 5a is attached to the laser diode mount (here a “B”-mount), by use of a suitable UV-curable glue. The SAC lens 5b is attached to the pump chamber housing the high thermal conductivity plate 6 and laser plate 7 using a second UV-curable glue.

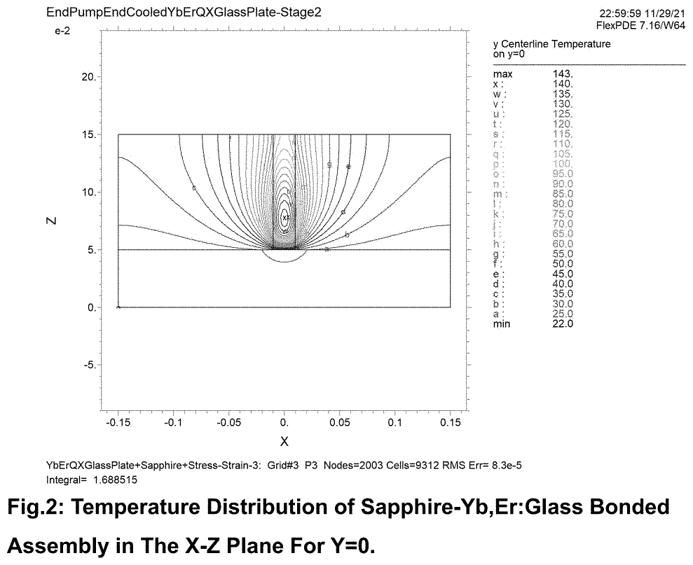

After installing the FAC and SAC lenses 5a, 5b, such that a near-square pump beam is produced, the beam transits the high thermal conductivity laser plate 6 with a very small loss because the surfaces facing the diode 4 and the laser plate 7 are anti-reflection (AR) coated at the pump wavelength, and the low thermal conductivity laser plate 6 has very small absorption at the pump wavelength. After transiting the high-k thermal conductivity plate 6, the near-square pump beam is then incident on the laser plate 7, which has high absorption at the pump wavelength, and produces a round laser beam from the low thermal conductivity laser plate 7. The pump absorption is highest just as it enters laser plate 7 since the pump intensity is highest there. With a bare laser plate in air, with no high k laser plate, the resulting temperature from the absorbed pump beam would be very high (typically 175-300° C.), maximized at the diode-facing surface, which leads to a bulging of the surface, potential fracture, and low gain. Placing the laser plate 7, however, in contact with a high-k plate 6, such as sapphire (Al₂O₃), SiC, diamond, or other such materials, results in the thermal distribution shown in FIG. 2, where the temperature right at the face is drawn down to the ambient temperature of the high-k plate 6 (here 22° C.). This eliminates bulging of the laser plate 7, reduces the fracture likelihood, and increases the gain at the location of the high-k−low-k interface. The maximum temperature in laser plate 7 has now moved about ⅓ of the laser plate thickness into the laser material. This also results in a decrease in thermal focusing in the laser plate 7.

The doping in the laser plate 7 is normally adjusted to result in most pump light being absorbed. In the case of an energy-transfer Yb,Er:Glass laser, the pump light near 975 nm is absorbed by the Yb³⁺ ions and internally transfers to Er ions that subsequently lase. For Nd:YVO4 lasers, the 808 nm pump light is directly absorbed by the Nd³⁺ ions.

After absorption by the laser plate 7, some pump light may not be absorbed and can affect the functioning of the VBG. This situation can be avoided by placing a high-reflection (HR) coating 7a on the face oriented towards the VBG, also increasing the pump light absorption.

After absorption by laser plate 7, the pump light is internally transformed into fluorescence in laser plate 7. When the VBG 8 is aligned so that the internal modulation planes are parallel to the rear face of the laser plate 7 (located at the high-k low-k interface), forming an optical resonator, lasing commences, seeded by the internal crystal fluorescence traveling back and forth between the reflective planes.

In some cases, the high and low k plates (high-k plate 6 and laser plate 7, respectively) may be glued together, although diffusion bonding is, in most cases, the preferred approach, resulting in the best heat diffusion from the low to the high k plate.

The beam emerging from the resonator is preferably circularly symmetric, with linear polarization. In addition to having a TEM₀₀ Gaussian transverse profile, the preferred beam also is single-longitudinal-mode (SLM). While many methods have appeared in the literature for achieving this, the preferred method of the present invention is to utilize a well-designed VBG 8.

After emerging from the VBG 8, the substantially round laser beam is then passed through a Faraday Isolator 10, which is used to ensure that backward traveling beams from optics further downstream of the Faraday isolator 10 do not damage the laser or the laser diode pumping the laser. Isolation ratios of 35-45 dB are typical for these devices.

Below is a brief listing of the benefits of the current invention.
1. A short resonator having lengths of <1 cm,
2. A common platform easily adaptable to other laser materials such as Nd:YAG, Nd:YVO4, Yb:YAG, and others,
3. Simple all linear configuration,
4. Minimization of laser plate average temperature, thereby increasing laser gain,
5. Elimination of strain distortion (bulging) at the interface of dielectric plate 6 and laser plate 7, thereby minimizing thermal distortion,
6. Using a VBG 8 to guarantee SLM behavior, if properly designed,
7. A VBG 8 locks the operating wavelength and has a small dependence on temperature, maintaining the output wavelength at a near-constant value. This feature is desirable for some applications.
8. Extracting heat from laser plate 7 is semi-parallel to the optical axis, further reducing thermal focusing, and
9. Minimization of temperature at the interface between high k and low k materials (dielectric plate 6 and laser plate 7) as illustrated in the temperature distribution of FIG. 2.

With respect to FIG. 2, FIG. 2 shows a temperature distribution of system 2 using Sapphire-Yb,Er:Glass bonded assembly in the X-Z Plane For Y=0. As discussed above, system 2 creates a minimization of temperature at the interface between high k and low k materials (dielectric plate 6 and laser plate 7), as illustrated in the temperature distribution of FIG. 2.

### Experimental Results

Below is Table 1 showing experimental results and the performance of various laser structures.

TABLE 1

| | Pump | Lasing | Outcoupler | VBG | Output | SLM Output | Mode | Mode |
|---|---|---|---|---|---|---|---|---|
| Laser | Wavelength | Wavelength | Reflectivity | DE | Power | Power | Structure | Structure |
| Material | (nm) | (nm) | (%) | (%) | (Outcoupler) | (VBG) | (Outcoupler) | (VBG) |
| Yb, Er:Glass | 975 | 1535 | 98 | 98 | 501 | 246 | MLM, MTM | SLM, STM |
| Nd:YVO₄ | 808 | 1064 | 95 | 95 | 1083 | 528 | SLM, MTM | SLM, STM |
| Nd:YVO₄ | 808 | 532 | 100 | N/A | 515 | 515 | SLM, STM | |
| Nd:YAG | 808 | 946 | 99 | N/A | 529 | 529 | SLM, MTM | |
| Nd:YAG | 808 | 1319 + 1338 | 99 | N/A | 554 | 554 | SLM, MTM | |
| Yb:YAG | 975 | 1029 | 98 | 99 | 180 | 56 | MLM, MTM | SLM, MTM |

Table 1 above shows results obtained from the present invention. Yb,Er:Glass, and Yb:YAG are both quasi-three-level lasers and have significant temperature sensitivity. Nd:YVO₄ and Nd:YAG are 4-level lasers. All results were obtained with configurations identical to or similar to FIG. 1: Mode structures obtained are shown.

Yb,Er:Glass (1535 nm): We have obtained most of our results to date with this laser, using both a standard outcoupler and a VBG 8. The maximum outcoupler power was >500 mW with a 98% R outcoupler, a world record, and 272 mW with a 98% DE VBG, which exceeds the world record.

Nd:YVO4 (1064 nm): For this laser, we obtained over 1 W of output power using a 95% R outcoupler and >500 mW of SLM output power with a 98% DE VBG 8.

Nd:YVO4 (532 nm): A green SLM, Single-Transverse Mode (STM), which is a TEM₀₀ Gaussian) laser was produced using a potassium titanyl phosphate (KTP) crystal bonded to the Nd:YVO₄ crystal. The outcoupler was on the KTP output surface and was close to 100% at 1064 nm. 515 mW was obtained at 532 nm.

Nd:YAG (946 nm): This laser was a flat laser plate 7 with an external 99% R outcoupler. The laser produced 529 mW of output power SLM, and the transverse mode was low order.

Nd:YAG (1319 nm And 1338 nm): For this laser, that was also a flat laser plate 7 with an external 99% R outcoupler, we achieved 554 mW of total output power with SLM achieved at both wavelengths. This laser, like the previous one, was also a multiple transverse mode (MTM) in a low-order mode. Both can be STM with better mode-matching.

Yb:YAG (1029 nm): We also demonstrated an SLM Yb:YAG laser that produced 180 mW multiple-longitudinal mode (MLM) and MTM using a 99% R outcoupler, and 56 mW SLM and MTM using a 98% DE VBG 8. This laser was also mode mismatched and, in the future, will run SLM and STM.

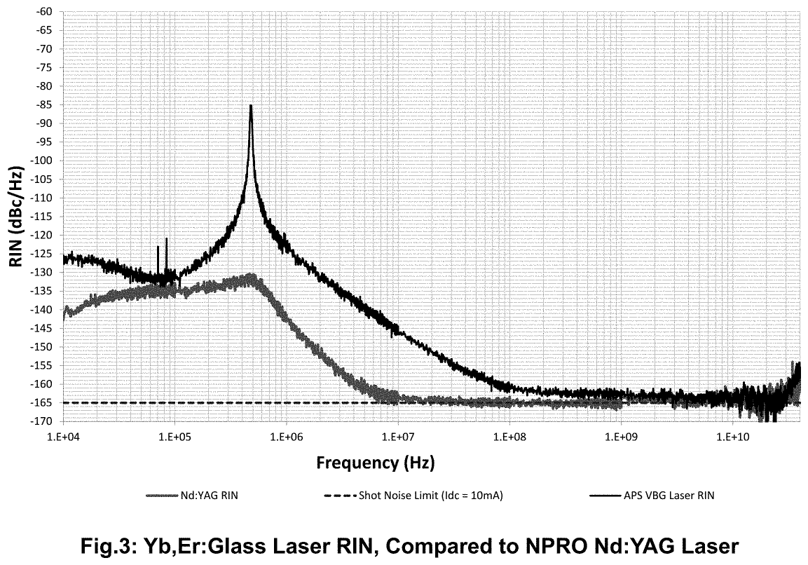

Regarding FIG. 3, FIG. 3 is a graphical illustration of the relative intensity noise (MN) spectrum of the present invention in relation to a known Nd:YAG; non-planar ring oscillator (NPRO). In particular, FIG. 3 shows measurements of the RIN spectrum of the Yb,Er:Glass laser of the present invention as compared to an Nd:YAG NPRO. The NPRO has electronic filtering to suppress RIN near the normal mode peak near 487 kHz; we have not yet implemented that feature. The laser of the present invention is shot-noise-limited at about 1 GHz and beyond; however, the region of most military interest.

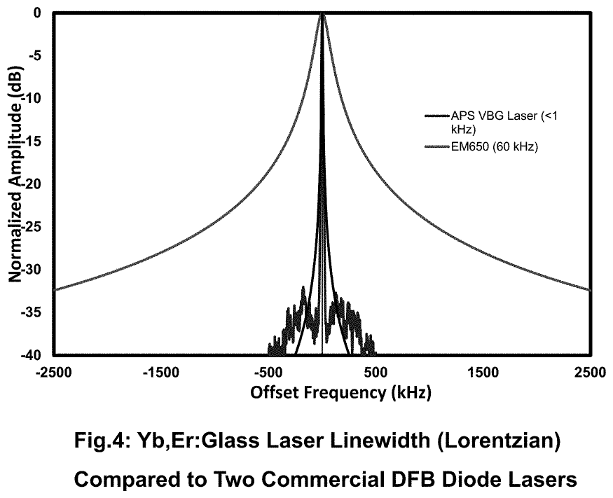

Regarding FIG. 4, FIG. 4 is a graphical illustration of the linewidth (Lorentzian) of the present invention as compared to two commercial distributed feedback (DFB) diode lasers. In particular, FIG. 4 shows a measurement of the bandwidth of the Yb,Er:Glass laser of the present invention as compared to two popular DFB diode lasers. The bandwidth value was measured as <1 kHz (FWHM) using an instrument-limited setup. Calculations using the Schawlow-Townes equation suggest a bandwidth in the mHz regime in the absence of technical noise.

### Summary of the Results Obtained

The current invention provides excellent results. Below is a non-exhaustive list of the results.

1. 1535 nm Output Wavelength Using Yb,Er:Glass Gain Medium

2. 50-130 mW Output Power After single-mode, polarization maintaining (SM PM) Fiber

3. Measured Shot Noise Limit of −165 dB/Hz From 1-100 GHz

4. Measured Linewidth <1 kHz Lorentzian (FWHM)

5. Compact Laser Package With Volume <22 cm³

While it has not been mentioned, one familiar with the art would realize that system 2 is not limited by the materials used to create each apparatus that comprises the invention. Any other material type can be chosen to comprise some or all of the elements of the radio frequency transceiver for laser systems device and apparatuses in various embodiments of the present invention.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A narrowband, single-longitudinal-mode (SLM) solid-state laser, comprising:
a laser diode assembly;
a beam-forming optics assembly located adjacent to the laser diode assembly;
a high thermal conductivity, electrically insulating dielectric plate located adjacent to the beam-forming optics assembly;
a low thermal conductivity laser plate operatively connected to the high thermal conductivity, electrically insulating dielectric plate;
a Bragg grating located adjacent to the low thermal conductivity laser plate; and
a Faraday isolator assembly located adjacent to the Volume Bragg grating.

2. The narrowband, single-longitudinal-mode (SLM) solid-state laser, according to claim 1, wherein the laser diode assembly further comprises:
a watt level continuous wave (CW) laser diode which can be used to end-pump an active-mirror amplifier.

3. The narrowband, single-longitudinal-mode (SLM) solid-state laser, according to claim 1, wherein the beam-forming optics assembly further comprises:
a fast-axis collimating (FAC) lens; and
a slow-axis collimating (SAC) lens located adjacent to the FAC lens.

4. The narrowband, single-longitudinal-mode (SLM) solid-state laser, according to claim 1, wherein the high thermal conductivity, electrically insulating dielectric plate further comprises:
a high thermal conductivity dielectric laser plate that is optically clear at a pump wavelength in order to efficiently optically-pump the low thermal conductivity laser plate and is optically clear at a lasing wavelength to produce an efficient laser.

5. The narrowband, single-longitudinal-mode (SLM) solid-state laser, according to claim 4, wherein the low thermal conductivity laser plate further comprises:
a diffusion bond between the high thermal conductivity, electrically insulating dielectric laser plate and the low thermal conductivity laser plate.

6. The narrowband, single-longitudinal-mode (SLM) solid-state laser, according to claim 1, wherein the Volume Bragg grating further comprises:
a narrowband, reflective Volume Bragg Grating.

7. The narrowband, single-longitudinal-mode (SLM) solid-state laser, according to claim 1, wherein the Faraday isolator assembly further comprises:
a Faraday Isolator that exhibits a transmission of 88-90% and isolation of 35-40 dB.

8. A method of constructing a narrowband, single-longitudinal-mode (SLM) solid-state laser, comprising:
providing a laser diode assembly;
locating a beam-forming optics assembly adjacent to the laser diode assembly;
locating a high thermal conductivity, electrically insulating dielectric plate adjacent to the beam-forming optics assembly;
connecting a low thermal conductivity laser plate to the high thermal conductivity, electrically insulating dielectric plate;
locating a Bragg grating adjacent to the low thermal conductivity laser plate; and
locating a Faraday isolator assembly adjacent to the Volume Bragg grating.

9. The method, according to claim 8, wherein the providing a laser diode assembly further comprises:
providing a watt level continuous wave (CW) laser diode which can be used to end-pump an active-mirror amplifier.

10. The method, according to claim 8, wherein the beam-forming optics assembly further comprises:
a fast-axis collimating (FAC) lens; and
a slow-axis collimating (SAC) lens located adjacent to the FAC lens.

11. The method, according to claim 8, wherein the high thermal conductivity, electrically insulating dielectric plate further comprises:
a high thermal conductivity dielectric laser plate that is optically clear at a pump wavelength in order to efficiently optically-pump the low thermal conductivity laser plate and is optically clear at a lasing wavelength to produce an efficient laser.

12. The method, according to claim 11, wherein the method further comprises:
creating a diffusion bond between the high thermal conductivity dielectric heatsink plate and the low thermal conductivity laser plate.

13. The method, according to claim 8, wherein the Volume Bragg Grating further comprises:
a narrowband reflective Volume Bragg Grating.

14. The method, according to claim 8, wherein the Faraday isolator assembly further comprises:
a Faraday Isolator that exhibits a transmission of 88-90% and isolation of 35-40 dB.

15. A method of operating a narrowband, single-longitudinal-mode (SLM) solid-state laser, comprising:
delivering a pre-determined current and voltage to a laser diode assembly to create an output pump beam;
delivering the output pump beam to a beam-forming optics assembly and utilizing the beam-forming optics assembly to convert the output pump beam into a substantially square pump beam;
delivering the substantially square pump beam to a high thermal conductivity electrically insulating dielectric plate and transiting the substantially square pump beam through the high thermal conductivity electrically insulating dielectric plate;
delivering the substantially square pump beam from the high thermal conductivity electrically insulating dielectric plate to a low thermal conductivity laser plate in order to produce a round laser beam from the low thermal conductivity laser plate;
delivering the substantially round laser beam from the low thermal conductivity laser plate to a Volume Bragg grating;
delivering the substantially round laser beam from the Volume Bragg grating to a Faraday isolator assembly, wherein the Faraday isolator assembly is used to ensure that any backward traveling beams from optics further downstream of the Faraday isolator do not damage the narrowband, SLM solid-state laser; and
delivering the substantially round laser beam from the Faraday isolator assembly.

16. The method, according to claim 15, wherein the laser diode assembly further comprises:
a watt level or higher continuous wave (CW) laser diode which can be used to end-pump an active-mirror amplifier.

17. The method, according to claim 15, wherein the beam-forming optics assembly further comprises:
a fast-axis collimating (FAC) lens; and
a slow-axis collimating (SAC) lens located adjacent to the FAC lens.

18. The method, according to claim 15, wherein the high thermal conductivity electrically insulating dielectric plate further comprises:
a high thermal conductivity dielectric plate that is optically clear at a pump wavelength passing through in order to efficiently optically-pump the lasing ions in the low thermal conductivity plate and is optically clear at a lasing wavelength to produce an efficient laser.

19. The method, according to claim 18, wherein the high thermal conductivity, electrically insulating dielectric plate further comprises:
a diffusion bond between the high thermal conductivity dielectric laser plate and the low thermal conductivity laser plate.

20. The method, according to claim 8, wherein the Volume Bragg Grating further comprises:
a narrowband reflective Volume Bragg Grating.
